(19) United States
(12) Patent Application Publication
(10) Pub. No.: US 2013/0313178 A1
(43) Pub. Date: Nov. 28, 2013

(54) LUBE OIL FILTER HOUSING

(71) Applicants: Patrick S. O'Hern, Bixby, OK (US); Scott Nemeth, Lititz, PA (US)

(72) Inventors: Patrick S. O'Hern, Bixby, OK (US); Scott Nemeth, Lititz, PA (US)

(73) Assignee: Clark Filter, Inc., Lancaster, PA (US)

(21) Appl. No.: 13/897,999

(22) Filed: May 20, 2013

Related U.S. Application Data
(60) Provisional application No. 61/650,164, filed on May 22, 2012.

(51) Int. Cl. B01D 35/30

(52) U.S. Cl. CPC B01D 35/306
USPC 210/232

(57) ABSTRACT

A lube oil filter housing including a tubular outer shell, a pair of covers, an inlet, an outlet, a clean fluid chamber and a filter element support is provided. The tubular outer shell and pair of covers define an internal cavity. A clean fluid chamber is interposed fluidly between an inlet and an outlet within the internal cavity. The clean fluid chamber includes at least one connection site for sealingly connecting with a filter element. The clean fluid chamber has at least one removable cover to provide access to a clean fluid portion defined by the clean fluid chamber. A removable filter element support is configured to support an end of the filter element opposite the end of the filter element that cooperates with the connection site. The outlet may include a removable connection tube removable from the tubular outer shell to provide access to the clean fluid portion.

### CROSS-REFERENCE TO RELATED PATENT APPLICATIONS

This patent application claims the benefit of U.S. Provisional Patent Application No. 61/650,164, filed May 22, 2012, the entire teachings and disclosure of which are incorporated herein by reference thereto.

### FIELD OF THE INVENTION

This invention generally relates to filter housings for housing one or more replaceable filter elements and particularly for housing one or more lube oil filter elements, and even more particularly to filter housings for use in filtering locomotive lube oil.

### BACKGROUND OF THE INVENTION

Locomotives include lube oil filter housings that house filter elements that filter the lube oil as it passes through the lube oil filter housing. The housing will include an outer shell and at least one cover that provide access to an internal cavity of the housing.

The filter elements will typically be replaceable so that once they are spent they can be removed from the housing through the cover. Typically, the housings will define a clean fluid area downstream of the filter elements. Unfortunately, from time to time the clean fluid area may become contaminated with debris or contaminants, such as after a catastrophic failure of an upstream system component.

It is therefore necessary to be able to remove the debris or contaminants from the clean fluid area. The present invention provides improvements over the current state of the art.

### BRIEF SUMMARY OF THE INVENTION

In one embodiment, a lube oil filter housing including a tubular outer shell, a pair of covers, an inlet, an outlet, a clean fluid chamber and a filter element support is provided. The pair of covers is hingedly attached to opposed ends of the tubular outer shell. The tubular outer shell and pair of covers define an internal cavity. The inlet provides access to the internal cavity, such as for dirty fluid to be filtered. The outlet provides an exit from the internal cavity. A clean fluid chamber is interposed fluidly between the inlet and the outlet. The clean fluid chamber is positioned within the internal cavity and separates the internal cavity into a clean fluid portion and a dirty fluid portion. The clean fluid chamber includes at least one connection site for sealingly connecting with a filter element. The connection site is substantially upstream from the clean fluid portion. The clean fluid chamber has at least one removable cover to provide access to the clean fluid portion. The filter element support is positioned within the tubular outer shell and is axially spaced from the connection site. The filter element support is configured to support an end of the filter element opposite the end of the filter element that cooperates with the connection site. The filter element support is removable. The filter element support is positioned axially between the removable cover and one of the covers of the tubular outer shell. By having the filter element support removable, access to the removable cover and the clean fluid portion is improved for cleaning purposes.

In one embodiment, a lube oil filter housing including a tubular outer shell, a pair of covers, an inlet, an outlet, and a clean fluid chamber. The pair of covers is hingedly attached to opposed ends of the tubular outer shell. The tubular outer shell and pair of covers define an internal cavity. The inlet provides access to the internal cavity, such as for dirty fluid to be filtered. The outlet provides an exit from the internal cavity. A clean fluid chamber is interposed fluidly between the inlet and the outlet. The clean fluid chamber is positioned within the internal cavity and separates the internal cavity into a clean fluid portion and a dirty fluid portion. The clean fluid chamber includes at least one connection site for sealingly connecting with a filter element. The connection site being substantially upstream from the clean fluid portion. The outlet includes a removable connection tube removable from the tubular outer shell to provide access to the clean fluid portion.

In one embodiment, the removable connection tube includes an elbow section and an extension section and a flanged portion. The flanged portion cooperates with a mounting boss attached to the tubular outer shell to secure the removable connection tube to the tubular outer shell. The removable connection tube provides improved access to the clean fluid chamber.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top plan view of a lube oil filter housing according to an embodiment of the invention;

FIG. 2 is a top isometric view of the lube oil filter housing of FIG. 1;

FIG. 3 is a partial cross-sectional illustration take about line 3-3 of FIG. 1;

FIG. 4 is a side plan view of the lube oil filter housing of FIG. 1;

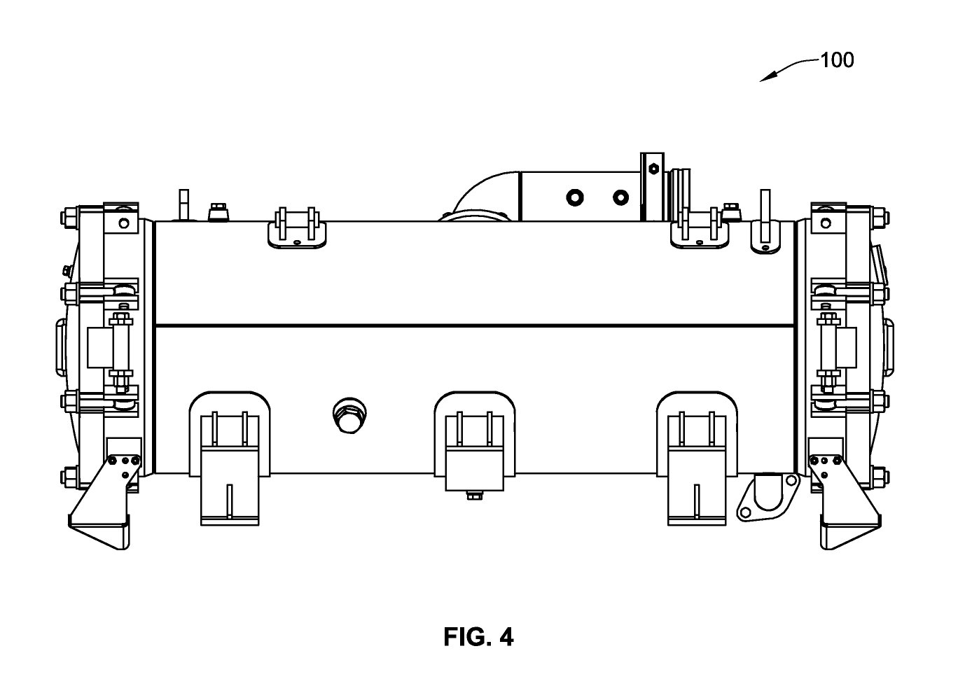

FIG. 5 is an enlarged cross-sectional illustration of the outlet of the lube oil filter housing of FIG. 1;

FIG. 6 is partial cross-sectional illustration of the lube oil filter housing of FIG. 1 illustrating a portion of a filter element support thereof;

FIG. 7 is a partial end view of the lube oil filter housing of FIG. 1 illustrating a filter element support;

FIG. 8 is an enlarged partial illustration of where a filter element support is connected to a filter housing; and

FIG. 9 is a filter element support according to an embodiment of the invention removed from the filter housing.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

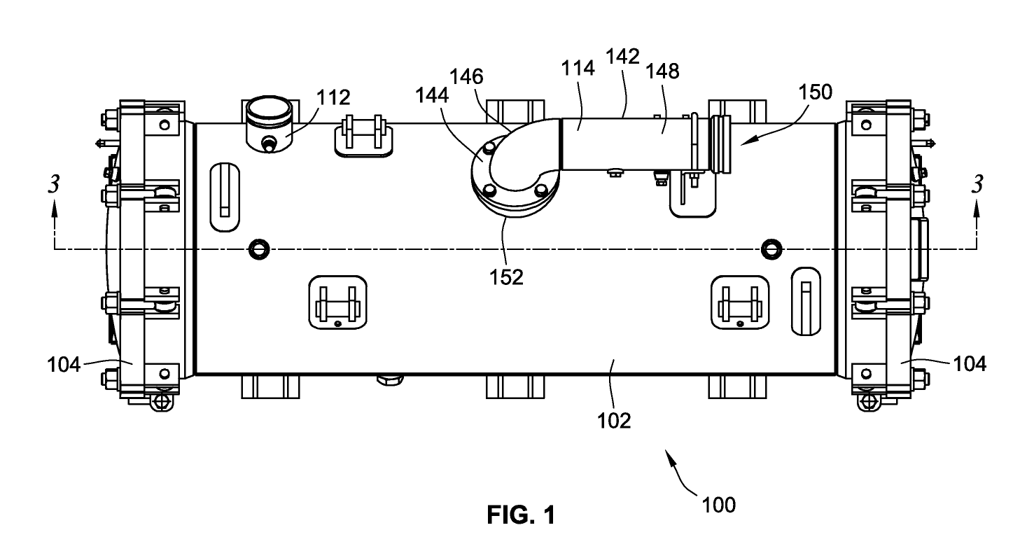

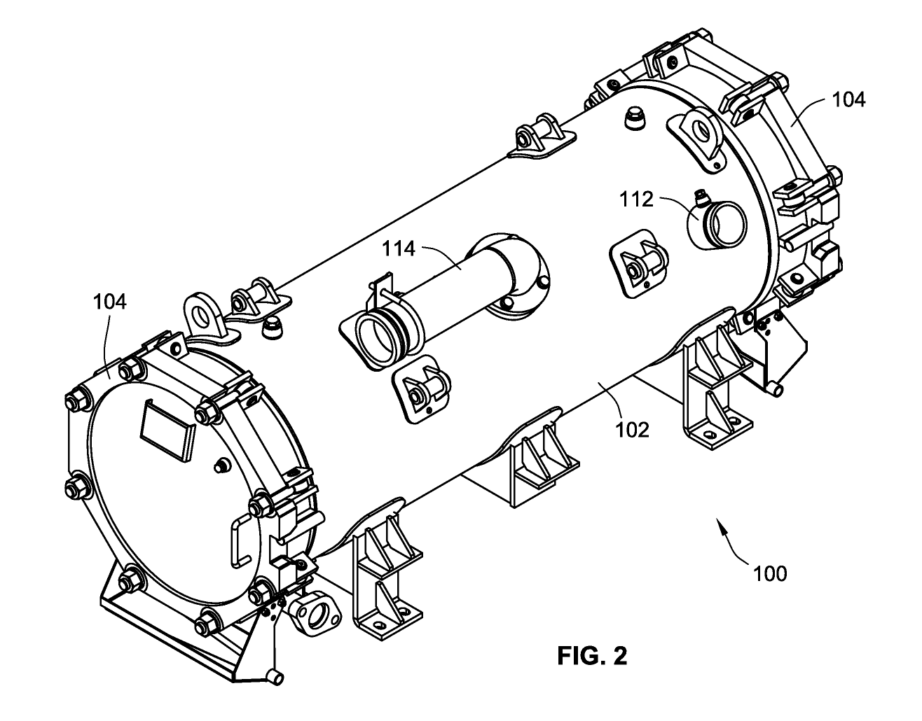

FIG. 1 is a top plan view illustration of a lube oil filter housing 100 (also referred to herein as “housing 100”) according to an embodiment of the present invention. FIG. 2 is a top isometric view of the housing 100 of FIG. 1. The housing 100 finds particular applicability to locomotive applications.

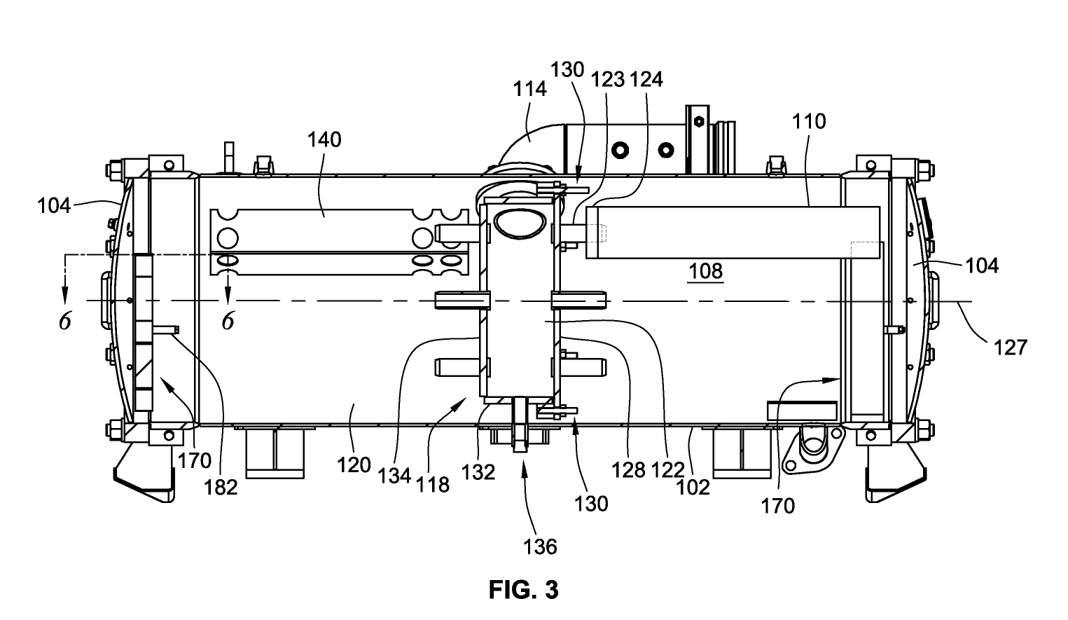

FIG. 3 is a simplified cross-sectional illustration of the lube oil filter housing 100, taken about line 3-3. With reference to FIGS. 1 and 2, the housing 100 includes a generally tubular outer shell 102 that has two covers 104 hingedly attached opposed ends thereof. The outer shell 102 and the covers 104 generally bound an internal cavity 108 in which filter elements are housed. In FIG. 3, only a single filter element 110 is shown in schematic form.

With reference to FIGS. 1-3, the filter housing 100 includes an inlet port 112 through which dirty lube oil enters the internal cavity 108 and an outlet port 114 through which clean lube oil exits the internal cavity 108.

The housing 100 includes a clean fluid chamber 118 within the internal cavity 108. The clean fluid chamber separates the internal cavity into a dirty fluid portion 120 and a clean fluid portion 122. When dirty fluid initially enters the internal cavity 108 of housing 100, it enters the dirt fluid portion 120. The fluid will then pass through the filter elements 110 and then into the clean fluid portion 122 generally defined by the clean fluid chamber 118. The cleaned fluid, i.e. fluid that has passed through a filter element 110 then exits the housing through outlet port 114 that is fluidly connected to the clean fluid chamber 118.

The filter elements 110 will typically extend in a generally horizontally cantilevered orientation from the clean fluid chamber 118. The clean fluid chamber 118 includes a plurality of filter stools in the form of filter connection pipes 123 to which the filter elements 110 are removably sealing attached. Typically, the filter elements will include a seal member 124, illustrated schematically in FIG. 3, that will seal with the filter connection pipes 123. Typically, a radially directed seal will be provided between the seal member 124 and the connection pipes 123 with the seal member 124 radially sealing on a radially outer surface of the connection pipes 123. However, alternative sealing and connections between the clean fluid chamber 118 and the filter elements 110 may be provided. Other connections, such as by non-limiting example, spin-on or axial connections, could be provided.

In the illustrated embodiment, the housing 100 accommodates fourteen separate replaceable filter elements 110 and thus the clean fluid chamber 118 will also include fourteen connection pipes 123. However, alternative embodiments may utilize more or less filter elements 110 and connection pipes 123. Further, in some embodiments, the filter elements may only be on a single side of the clean fluid chamber 118. Typically the number of filter elements is based on the flow capacity necessary for the system.

The filter elements 110 extend generally parallel to a central axis 127 of the outer shell 102.

The clean fluid chamber 118 in the illustrated embodiment includes a removable cover 128 that can be removed from the rest of the clean fluid chamber 118. The removable cover allows for access into the clean fluid chamber 118 in the event it is desired to clean the clean fluid chamber 118, such as after a catastrophic failure of a component of the lube oil system upstream from the lube oil housing 100. Typically, the cover 128 is bolted to the rest of the clean fluid chamber 118 using bolted connections 130.

Preferably, the cover 128 is a generally flat plate that is substantially orthogonal to the central axis 127 of the filter housing 100. The cover 128 will include one set of the connection pipes 123 (i.e. seven connection pipes 123 in the instant embodiment).

The clean fluid chamber 118 will also include a tubular body section 132 and a closed end cover 134. The removable cover 128 operably attaches to one end of the tubular body section 132 while the closed end cover 134 is preferably permanently attached to the opposed axial end of the tubular body section 132.

The clean fluid outlet 114 is in operable fluid communication with the interior of the clean fluid chamber 118 that defines the clean fluid portion 122. Additionally, a drain 136 may extend through the outer shell 102 and through the tubular body section 132 to fluidly communicate with the interior of the clean fluid chamber 118. Preferably, the outlet 114 fluidly communicates with the interior of the clean fluid chamber 118 at a position vertically above the drain 136, and more preferably at least above a vertical midpoint of the clean fluid chamber 118. This reduces the likelihood of any debris or contaminants that may get into the clean fluid chamber 118 from actually passing into the outlet 114.

A baffle 140 is positioned adjacent the dirty fluid inlet 112 and helps redirect the inflowing dirty fluid. The baffle prevents the stream of dirty fluid that enters the internal cavity 108 from directly acting on the filter elements 110 in front of the inlet 112 to avoid damaging the filter elements 110 that are positioned in-line with the inlet 112. The baffle 140 may be welded or otherwise secured to the inner surface of the outer shell 102.

With reference to FIG. 1, the outlet 114 of the illustrated embodiment includes a removable flanged connection tube 142 rather than a fixed structure. The use of the flanged connection tube 142 allows for removal of the flanged connection tube 142 to provide further access into the clean fluid chamber 118. More particularly, if it is desired to have access to the interior of the clean fluid chamber 118, a user can remove the flanged connection tube 142 of outlet 114 and have direct access into the interior of the clean fluid chamber 118, i.e. the clean fluid portion 122 of the internal cavity 102 of the housing 100.

The flanged connection tube 142 includes a flange portion 144, an elbow portion 146 and an extension portion 148. Preferably, these components are all integrally welded into a single component. The extension portion 148 preferably includes a connection end that includes an adaptor 150 configured for sealingly interconnecting with other piping of the lube oil system for transporting the clean lube oil to downstream components of the system. Sensors for monitoring the state of the clean fluid exiting the housing 100 can be mounted in the flanged connection tube 142, and preferably, within the extension portion 148 thereof.

A mounting boss 152 is preferably mounted to the outer surface of the outer shell 102 that provides a generally flat surface that cooperates with a corresponding flat surface of the flange portion 144 of the flanged connection tube 142. A sealing gasket may be mounted between the mounting boss 152 and the flanged portion 142 in operation. One or both of the mating surfaces provided by the mounting boss 152 and the flanged portion 144 may include one or more grooves or ribs that either receive or engage any such sealing gasket to either mount the gasket or provide an improved sealing engagement therewith. The inclusion of any such grove or rib shall not prevent the structure from being considered to have a “generally flat surface.”

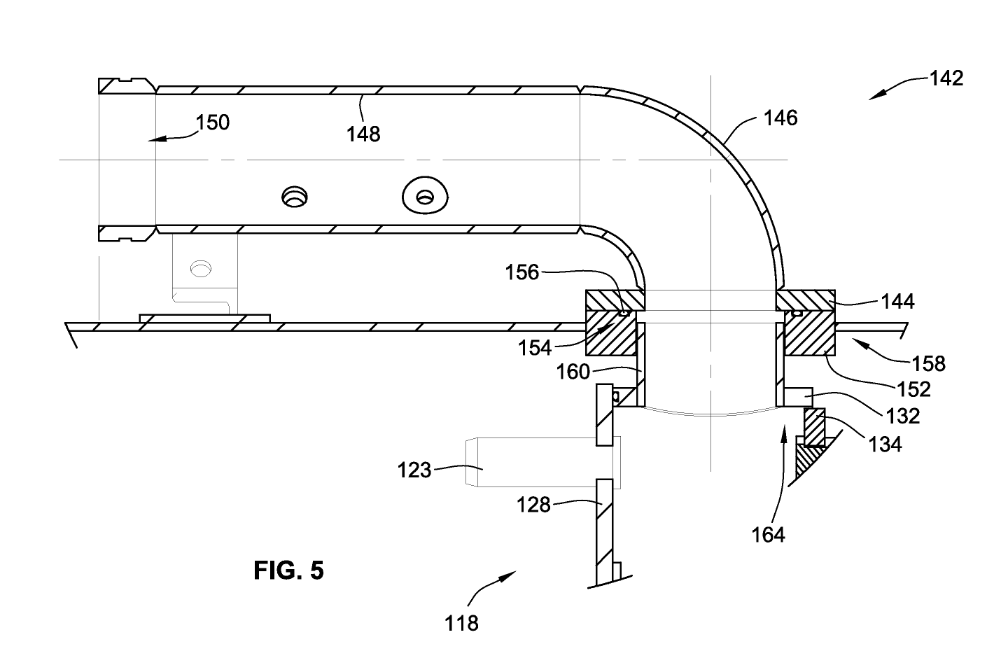

With reference to FIG. 5, the mounting boss 152 includes a groove 154 that carries a sealing gasket 156. To improve strength and welding locations, the mounting boss 152 may be inserted through an aperture 158 formed through the outer shell 102 such that the mounting boss 152 can be welded to the outer shell 102 on both the inside and outside of the outer shell 102.

An outlet connection tube 160 fluidly connects the mounting boss 152 and the tubular body section 132 of the clean fluid chamber 118. The outlet connection tube 160 has an outer diameter that is less than an inner diameter of the mounting boss 152. The outlet connection tube 160 is received axially into the mounting boss 152. The outlet connection tube 160 also extends radially through an aperture 164 in the tubular body section 132. Again, this allows for making a stronger welded connection.

FIG. 5 also illustrates the sealing interface between the removable cover 128 and the tubular body section 132.

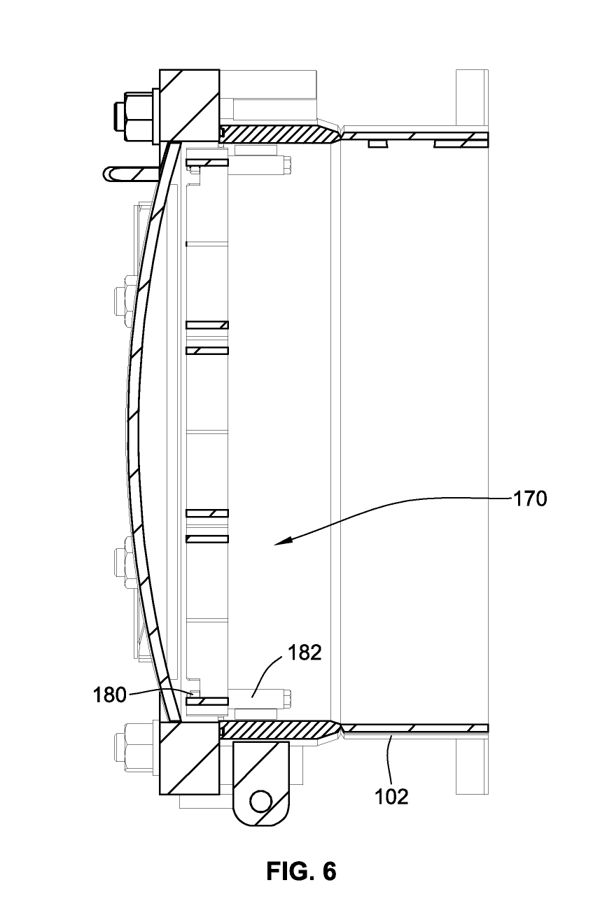

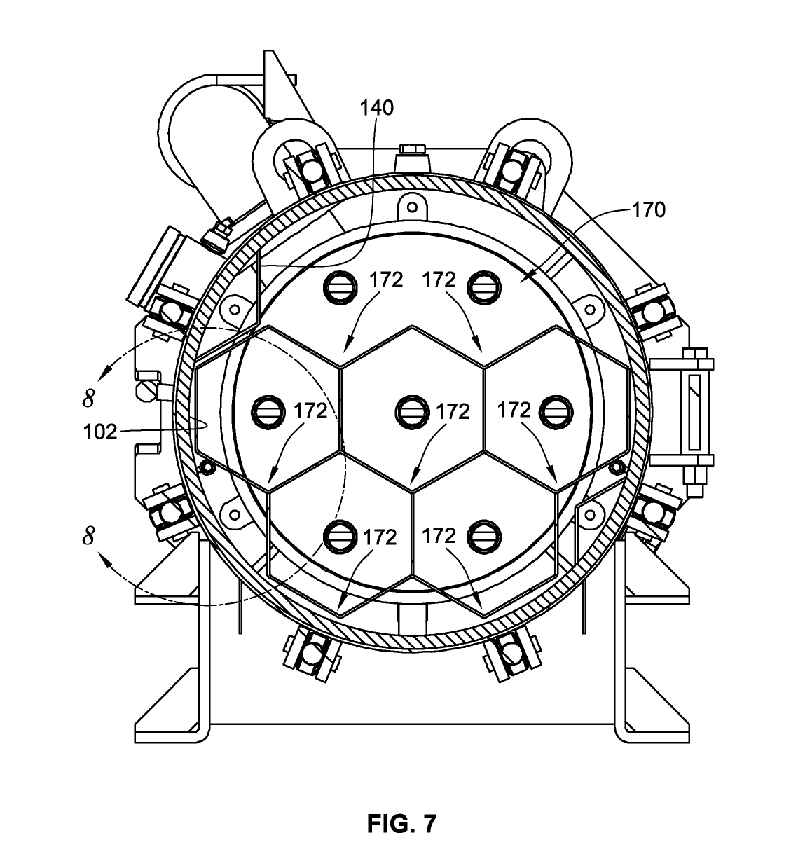

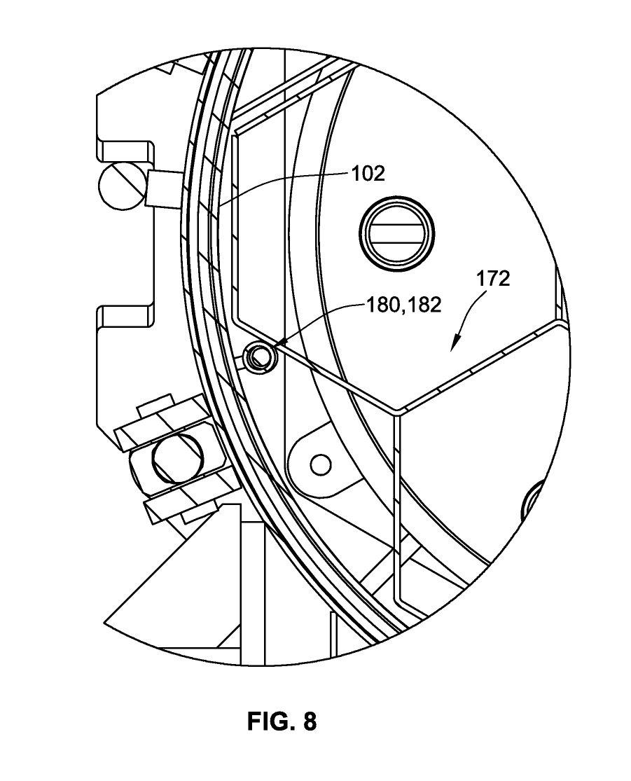

With reference to FIGS. 6-8, the lube oil filter housing 100 includes filter element supports 170 for supporting the free end of the filter elements, i.e. the end of the filter elements 110 that is opposite the end connected to connection pipes 123 (only a single one of the filter element supports 170 is illustrated in these figures).

The filter element supports 170 are generally honeycomb shaped in the illustrated embodiment. The filter element supports 170 define a plurality of receiving troughs 172 that receive the distal end of the filter elements. In the illustrated embodiment, the receiving troughs 172 are generally v-shaped. The illustrated filter element support 170 includes three vertically spaced rows of receiving troughs 172. The top and bottom rows include two receiving troughs 172 and the middle row includes three receiving troughs 172.

The filter element supports 170 are operably mounted to the outer shell 102 proximate the covers 104.

Preferably, the filter element support 170 on the side of the clean fluid chamber 118 is removable to provide access to the removable cover 128 of the clean fluid chamber 118. This allows a user to better access the interior of the clean fluid chamber 118 for cleaning purposes. In the illustrated embodiment, both filter element supports 170 are removable.

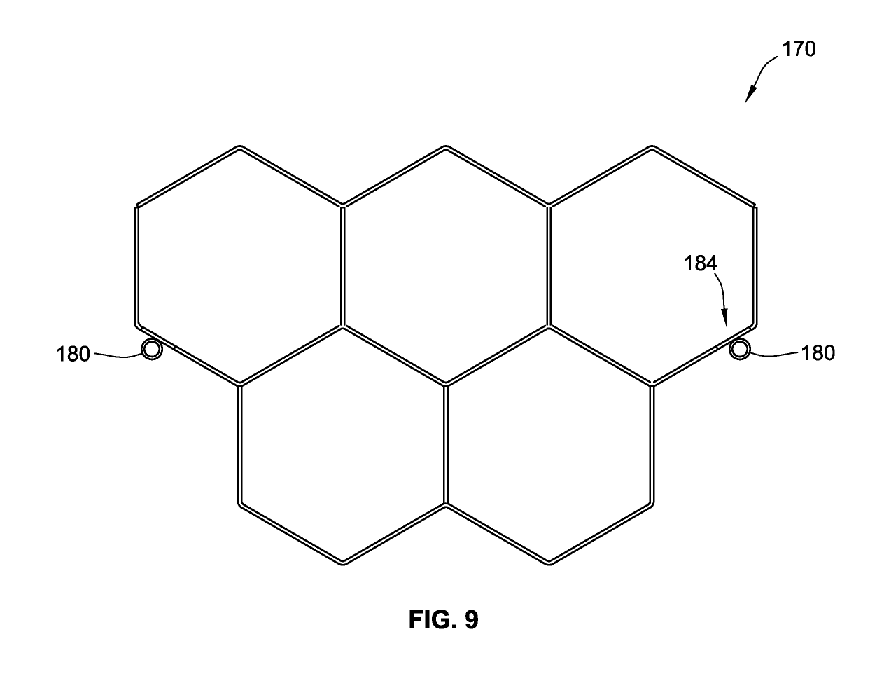

With reference to FIG. 9, the filter element supports 170 include a pair of mounting pipes 180. The housing 100 includes a pair of corresponding mounting pipes 182 (see FIG. 1) that align with the mounting pipes 180. Bolts pass through the aligned mounting pipes 180, 182 to releasably secure the filter element supports 170 to the outer shell 102.

The filter element support 170 includes a pair of notches 184 that extend axially outward and away from the clean fluid chamber 118.

To reduce the use of material, five of the receiving troughs 172 form part of hexagonal chambers. The two top receiving troughs 172 do not have a top portion to the chambers to reduce material use.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A lube oil filter housing comprising:
a tubular outer shell;
a pair of covers hingedly attached to opposed ends of the tubular outer shell, the tubular outer shell and pair of covers defining an internal cavity;
an inlet providing access to the internal cavity;
an outlet providing an exit from the internal cavity;
a clean fluid chamber interposed fluidly between the inlet and the outlet, the clean fluid chamber positioned within the internal cavity and separating the internal cavity into a clean fluid portion and a dirty fluid portion, the clean fluid chamber including at least one connection site for sealingly connecting with a filter element, the connection site being substantially upstream from the clean fluid portion, the clean fluid chamber having at least one removable cover to provide access to the clean fluid portion;
a filter element support within the tubular outer shell axially spaced from the connection site configured to support a second free end of the filter element opposite a first end that cooperates with the connection site, the filter element support being removable.

2. The lube oil filter housing of claim 1, wherein the inlet and outlet extend through the tubular outer shell.

3. The lube oil filter housing of claim 1, wherein the removable cover of the clean fluid chamber is positioned entirely within the tubular outer shell.

4. The lube oil filter housing of claim 1, wherein the clean fluid portion of the internal cavity is positioned within the clean fluid chamber, the outlet being in fluid communication with the clean fluid portion outlet.

5. The lube oil filter housing of claim 4, wherein the clean fluid chamber further includes a tubular body section and closed end cover attached to an opposite end of the tubular body section as the removable cover, the tubular body section, closed end cover and the removable cover generally defining the clean fluid portion.

6. The lube oil filter housing of claim 5, wherein the at least one connection site includes at least a first connection site and a second connection site, the first connection site provides fluid communication into the clean fluid portion through the closed end cover and the second connection site provides fluid communication into the clean fluid portion through the removable cover.

7. The lube oil filter housing of claim 1, wherein the filter element support is generally honeycomb shaped and defines a plurality of filter element receiving troughs in which the first end of a filter element is received and supported.

8. The lube oil housing of claim 7, wherein the filter element support provides a plurality of rows of receiving troughs with a first row of receiving troughs vertically above a second row of receiving troughs.

9. The lube oil housing of claim 8, wherein the second row of receiving troughs are formed in part by a polygonal chamber, the top portion of the polygonal chamber of a least of the receiving troughs of the second row defining, in part, a portion of the receiving trough of the first row of receiving troughs, the first row receiving troughs not having a top portion.

10. The lube oil housing of claim 1, wherein the outlet including a removable connection tube removable from the tubular outer shell to provide access to the clean fluid portion.

11. The lube oil filter housing of claim 10, wherein the removable connection tube includes an elbow section and an extension section and a flanged portion, the flanged portion cooperating with a mounting boss attached to the tubular outer shell to secure the removable connection tube to the tubular outer shell.

12. A lube oil filter housing comprising:
a tubular outer shell;
a pair of covers hingedly attached to opposed ends of the tubular outer shell, the tubular outer shell and pair of covers defining an internal cavity;
an inlet providing access to the internal cavity;
an outlet providing an exit from the internal cavity;
a clean fluid chamber interposed fluidly between the inlet and the outlet, the clean fluid chamber positioned within the internal cavity and separating the internal cavity into a clean fluid portion and a dirty fluid portion, the clean fluid chamber including at least one connection site for sealingly connecting with a filter element, the connection site being substantially upstream from the clean fluid portion; and
the outlet including a removable connection tube removable from the tubular outer shell to provide access to the clean fluid portion.

13. The lube oil filter housing of claim 12, wherein the removable connection tube includes an elbow section and an extension section and a flanged portion, the flanged portion cooperating with a mounting boss attached to the tubular outer shell to secure the removable connection tube to the tubular outer shell.

14. The lube oil filter housing of claim 13, further comprising an outlet connection tube that fluidly connects the mounting boss to the clean fluid portion.

15. The lube oil filter housing of claim 14, wherein the clean fluid chamber further includes a tubular body section and closed end cover attached to an opposite end of the tubular body section as the removable cover, the tubular body section, closed end cover and the removable cover generally defining the clean fluid portion.

16. The lube oil filter housing of claim 15, wherein the at least one connection site includes at least a first connection site and a second connection site, the first connection site provides fluid communication into the clean fluid portion through the closed end cover and the second connection site provides fluid communication into the clean fluid portion through the removable cover.

17. A lube oil filtering apparatus comprising:
a plurality of filter elements;
a lube oil filter housing including:
a tubular outer shell;
a pair of covers hingedly attached to opposed ends of the tubular outer shell, the tubular outer shell and pair of covers defining an internal cavity;
an inlet providing access to the internal cavity;
an outlet providing an exit from the internal cavity;
a clean fluid chamber interposed fluidly between the inlet and the outlet, the clean fluid chamber positioned within the internal cavity and separating the internal cavity into a clean fluid portion and a dirty fluid portion, the clean fluid chamber including a plurality of filter element connection sites to which a first end of the filter elements is removably, sealingly connected, the connection sites being substantially upstream from the clean fluid portion, the clean fluid chamber having at least one removable cover to provide access to the clean fluid portion;
a filter element support within the tubular outer shell axially spaced from the connection site configured to support a second free end of the filter elements opposite the first end that cooperates with the connection site, the filter element support being removable; and
a removable connection tube forming part of the outlet being removable from the tubular outer shell to provide access to the clean fluid portion.
